(19) United States
(12) Patent Application Publication
(10) Pub. No.: US 2011/0076396 A1
(43) Pub. Date: Mar. 31, 2011

(54) Method of forming a calcium phosphate coating within a porous material

(76) Inventors: Limin Guan, Toronto (CA); John E. Davies, Toronto (CA)

(21) Appl. No.: 12/585,899

(22) Filed: Sep. 28, 2009

(51) Int. Cl. B05D 7/22

(52) U.S. Cl. 427/230

(57) ABSTRACT

The present invention relates to a method of coating a porous material such as a medical implant with a layer of calcium phosphate, wherein the material is submersed in an aqueous solution of calcium, phosphate and carbonate ions, and the pH of the solution is gradually increased. A calcium phosphate coating is formed on an internal surface of the porous material by agitating the solution during coating formation.

### FIELD OF THE INVENTION

This invention relates to methods of coating medical implants for improved biocompatibility and bone adhesion. More particularly, the present invention relates to methods of internally coating porous medical implants with a calcium phosphate layer.

### BACKGROUND OF THE INVENTION

Calcium phosphate coatings are well known to improve the biocompatibility of implantable medical devices by allowing for the ingrowth of natural bone into and around the device. The coating supports the formation of chemical bonds between the device and natural bone, thus dramatically improving the osteoconductivity of implanted devices such as bone prosthesis and dental implants. Moreover, these coatings have been reported to eliminate the early inflammatory responses provoked by polymeric implants or polymer covered implants (e.g. PLGA). Such benefits can be further enhanced by incorporating bioactive materials during the formation of the coating.

Early coating methods suffered from a number of drawbacks that have limited their clinical effectiveness and use. For example, the electrophoresis method, while providing a low-temperature process, suffers from low bond strength and typically requires an additional post-process sintering step. While the plasma spray method provides a coating with a high bond strength, the high temperatures required for the process results in the decomposition of the coating and limit the number of substrates that may be used (e.g. plasma spraying is incompatible with most polymer substrates). Furthermore, line-of-sight processes such as the plasma spray process suffer from very poor infiltration of porous materials.

More recently, biomimetic methods have sought to overcome many of these drawbacks by providing a low-temperature process involving an aqueous environment that is designed to simulate or approximate natural biological conditions. Initial biomimetic approaches employed low-concentration simulated body fluid (SBF), which was typically prepared having very low calcium and phosphate concentrations that mimic the natural concentrations of these ions on the body (e.g. typically about 2.5 mM and 1.0 mM, respectively, for 1×SBF [1]). In such low concentration SBF methods, the pH of the coating solution was usually adjusted to a value of about 7.4 using buffering agents, such as TRIS [2] or HEPES [3].

Unfortunately, such methods often required incubation periods exceeding three to four weeks for the formation of a suitable layer of calcium phosphate on a substrate, with frequent changes of the coating solution. In order to decrease the coating time for the process, many sought to increase the ionic concentration of the aqueous environment to levels many times that of SBF.

Barrere et al. [6-8] achieved this goal by providing a process employing a 5×SBF solution (with an initial pH value close to 5.8) that required only hours to form a coating on a substrate. The method also provided the benefit of not requiring any buffering agent, such as TRIS or HEPES. Two coating solutions were employed in the process, and pH was increased to higher values to achieve nucleation of calcium phosphate by bubbling CO2 gas into the reaction chamber. Using such a process, coating thicknesses in the range of tens of millimeters were achieved after 6 h of immersion and incubation.

A similar method is disclosed in Japanese Patent Application No. 08040711, which teaches a process of forming a calcium phosphate coating, in which carbon dioxide gas is passed through a SBF solution to dissolve calcium phosphate and aid in the formation of the coating. In this known process, sodium hydroxide is present in the calcifying solution, which significantly increases the pH. As a result, a high pressure of carbon dioxide is needed in order to obtain a low enough pH to dissolve sufficient calcium phosphate.

U.S. Pat. Nos. 6,207,218 (Layrolle, 2001), 6,733,503 (Layrolle, 2004), and 6,994,883 (Layrolle, 2006) also describe a biomimetic method in which an implant is submersed in an aqueous solution of magnesium, calcium and phosphate ions through which a gaseous weak acid is passed. The solution is subsequently degassed, which raised the pH, and the coating is allowed to precipitate onto the implant (some growth factors can be also incorporated into the coating via this process).

Such advancements clearly improve over previous 1×, 1.5× and 2.×SBF biomimetic coating methods by providing new methods that require less incubation time and less coating solution, but still suffer from the disadvantage of requiring an extra gas supply. Furthermore, the initially low pH of the coating solution (e.g. 5.2) may denature some growth factors intended to be incorporated into the coating.

An improved method was disclosed in U.S. Pat. No. 6,569,489 (Li, 2003), in which a calcium phosphate coating is formed without the need for bubbling carbon dioxide gas though the aqueous coating solution. The method instead relies on the addition of bicarbonate ions to a high-concentration SBF coating liquid, which interact with the atmosphere above the liquid interface to raise the pH of the solution for the formation of a calcium phosphate layer on a substrate. However, the process as taught requires the control of the partial pressure of carbon dioxide in the atmosphere above the liquid, which increases the complexity of the process. Similar methods were subsequently disclosed in U.S. Patent Application No. US2003/0113438 (Liu, 2007) and a publication by Tas et al. [9].

While the above methods provide rapid, low-temperature methods of producing a calcium phosphate coating on a medical device, they are static methods that are optimized for the coating of medical devices having a solid substrate as opposed to implants exhibiting a porous internal structure. Furthermore, depending on the selected ionic concentration and the coating rate, the coating may not be evenly distributed along the substrate surface.

The inability of such prior art methods to internally coat porous structures is particularly evident in Li (U.S. Pat. No. 6,659,489), which suggests that the method disclosed is only adapted to shallow porous structures. For example, Li discloses that the method is suitable for use in coating porous undercut and recessed surfaces. However, porous undercut structures and recessed surfaces are locally porous, with porosity that does not extend deep into the implant or device. Furthermore, Li discloses that the method can be applied to porous beaded substrates. However, porous beaded structures are obtained by sintering a powder onto a solid surface, thereby producing a shallow, locally-porous shell on an otherwise solid material.

The methods described above, and particularly the method disclosed by Li, are thus only static methods that are adapted to shallow porous or recessed features, rather than deep porosity or porosity extending throughout the volume of the structure. What is therefore needed is an improved method of coating porous materials that enables the efficient and homogenous coating within porous materials.

### SUMMARY OF THE INVENTION

The present invention provides a simple method for coating the internal surface of a porous material, such as a medical implant, with a layer of calcium phosphate. A porous material is submerged or contacted with an aqueous solution that contains calcium ions, phosphate ions, and carbonate ions. The pH of the solution is allowed to gradually rise, during which time the solution is agitated, thereby enabling the formation of a calcium phosphate layer internally within the porous material.

Accordingly, in one aspect of the invention, there is provided a method of forming a calcium phosphate coating on internal surface of a porous material, comprising the steps of:

providing an aqueous solution comprising calcium ions, phosphate ions, and carbonate ions, wherein the aqueous solution has a temperature less than approximately 100° C. and an initial pH in the range of approximately 6.0 to 7.5;

contacting the porous material with the solution; and

agitating the solution while forming the calcium phosphate coating on the internal surface of the porous material.

The calcium phosphate coating is preferably hydroxyapatite, and the solution is preferably agitated by stirring the solution at a rate of approximately 50-1000 revolutions per minute.

In another aspect of the invention, there is provided a method of forming a calcium phosphate coating on internal surface of a macroporous material comprising a connected network of macropores, the method comprising the steps of:

providing an aqueous solution comprising calcium ions, phosphate ions, and carbonate ions, wherein the aqueous solution has a temperature less than approximately 100° C. and an initial pH in the range of approximately 6.0-7.5;

contacting the porous material with the solution; and

stirring the solution while forming the calcium phosphate coating on the internal surface of the porous material.

In yet another aspect of the invention, there is provided a method of forming a calcium phosphate coating on internal surface of a porous material comprising a composite material formed of a macroporous polymer scaffold and calcium phosphate particles, the method comprising the steps of:

providing an aqueous solution comprising calcium ions, phosphate ions, and carbonate ions, wherein the aqueous solution has a temperature in the range of approximately 20° C.-50° C. and an initial pH in the range of approximately 6.0-7.5;

contacting the porous material with the solution; and

stirring the solution at a speed of approximately 200-400 revolutions per minute while forming the calcium phosphate coating on the internal surface of the porous material.

A further understanding of the functional and advantageous aspects of the invention can be realized by reference to the following detailed description and drawings.

### BRIEF DESCRIPTION OF THE DRAWINGS

FIG. 1 shows the X-ray diffraction spectrum of the precipitate from the calcifying solution.

FIGS. 2 (a)-(c) shows scanning electron microscope images of the coated PLGA/CaP composite scaffold section at increasing magnification.

FIG. 3 shows scanning electron microscope images of the coated PEEK polymer surface at increasing magnification.

FIG. 4 shows histological images of the coated scaffold implanted in rat femur for 2 weeks. The samples were wax embedded and HE stained. FIG. 4(a) shows a field of view spanning 861 μm, while FIG. 4(b) shows a magnified view spanning 345 μM, and S represents the scaffold, C represents the coating and B stands for newly formed bone

### DETAILED DESCRIPTION OF THE INVENTION

Generally speaking, the systems described herein are directed to a method of internally coating a porous material with a layer of calcium phosphate. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to a method of internally coating a porous material with a layer of calcium phosphate.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the terms “about” and “approximately, when used in conjunction with ranges of dimensions of particles, compositions of mixtures or other physical properties or characteristics, is meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

As used herein, the coordinating conjunction “and/or” is meant to be a selection between a logical disjunction and a logical conjunction of the adjacent words, phrases, or clauses. Specifically, the phrase “X and/or Y” is meant to be interpreted as “one or both of X and Y” wherein X and Y are any word, phrase, or clause.

As used herein, the term “macroporous” means a porous material with an average pore diameter that is greater than approximately 10 microns in diameter, and the term “microporous” means a porous material with an average pore diameter that is less than approximately 10 microns in diameter.

As used herein, the term “calcium phosphate” generally refers to a group of phosphate minerals, including amorphous or crystalline hydroxyapatite (HA), β-tricalcium phosphate (TCP), tetracalcium phosphate (TTCP), dicalcium phosphate anhydrous (DCPA) or dicalcium phosphate dihydrate (DCPD), octacalcium phosphate (OCP).

As used herein, the term “porous” means having a material having pores or voids sufficiently large and sufficiently interconnected to permit passage of fluid.

As used herein, the term “agitation” may refer to any means of agitation of a liquid. Exemplary agitation methods include stirring, shaking, orbital mixing, magnetic mixing, vortexing and thermal convection.

In a preferred embodiment of the invention, a method is provided of forming a calcium phosphate coating on an internal surface of a porous material. The inventors of the present invention have discovered that deeply nested surfaces within a material having an interconnected porous network may be effectively and uniformly coated with an apatatic layer by agitating a calcifying solution during the formation of a calcium phosphate layer. Unlike prior art methods, in which only shallow porous surfaces that are superficially coated with a calcium phosphate layer, the present invention provides methods for coating the internally connected network of a porous material with a calcium phosphate layer. Additionally, complex shaped implants (such as porous or beaded surfaces) can be uniformly covered with a layer of calcium phosphate. As will be discussed in the following examples, the biocompatibility and osteoconductivity of such coated devices have been demonstrated by implantation in animal models.

Unlike prior art methods, the present invention includes the new and inventive step of agitating the calcifying solution during calcium phosphate layer formation to provide a rapid process for internally coating porous materials. The agitation enhances the flow of liquids into a porous structure, which replenishes the local ionic concentration within the pores. Without this replenishment, the local depletion of the ionic concentration would cause a decreased rate of calcium phosphate deposition internally within the porous material. The present inventors have discovered that agitation, preferably stirring or mixing with a mixing speed in the range of approximately 50-1000 revolutions per minute, and more preferably 200-400 revolutions per minute, enables the internal coating of pores extending deeply within or throughout the volume of a porous material.

In prior art methods, attempts to solve this problem have included frequent changing and replenishment of the calcifying solution, which has several drawbacks. A major drawback of changing the calcifying solution is this method is unable to achieve a satisfactory internal coating. Moreover, since this process typically must be done on a frequent basis, this complicates the process and makes it costly by consuming high volume of calcifying solution.

The present invention therefore provides a route to coat very complex porous structures rather than simply superficial porous coatings on an otherwise solid surface, and is adaptable to a wide range of low temperature, biomimetic-type processes employing a calcifying solution for the formation of an apatatic layer. The methods disclosed herein are particularly suited to the coating of medical implants such as porous scaffolds that contain a macroporous network of pores extending throughout their volume.

In a preferred embodiment of the invention, a porous material is internally coated by contacting the material with an aqueous calcifying solution comprising of calcium, phosphate, and carbonate ions and agitating the solution during the nucleation, precipitation, and formation of calcium phosphate layer internally within the porous material.

The calcifying solution comprises a concentration of calcium and phosphate ions. The concentration of calcium ions is preferably in the range of approximately 1-50 mM, and more preferably in the range of about 7-14 mM. Calcium ions may be provided by dissolving a quantity of CaCl₂.2H₂O or CaCl₂ in an aqueous solution. The concentration of phosphate ions is preferably in the range of approximately 1-25 mM, and more preferably in the range of about 3-6 mM. Phosphate ions may be provided by dissolving a quantity of Na₂HPO₄ or Na₂HPO₄.2H₂O into the aqueous solution.

While the present invention may be adapted to a wide range of methods involving the use of a calcifying solution for the formation of a calcium phosphate layer, it is particularly well suited to methods in which the pH of the calcifying solution is slowly raised to a level at which nucleation and precipitation are initiated. In one embodiment, the pH may be increased by bubbling carbon dioxide gas in the calcifying solution. In a preferred embodiment, the pH is raised by providing a concentration of bicarbonate ions that causes the release of carbon dioxide from the solution. The pH of the solution is preferably initially in the range of 6.0 to 7.5, and more preferably in the range of 6.2-6.8

Accordingly, in a preferred embodiment of the invention, carbon dioxide is produced in the solution by the reaction of bicarbonate ions. The carbon dioxide is gradually is released out of the solution while the solution is agitated, causing the pH of the calcifying solution to rise. The rise in the pH of the solution and the saturation of the solution is increased while agitating the solution until the nucleation of calcium phosphate crystals on the internal surfaces of the porous material (such as an implantable medical device) occurs. The nucleation layer deposits and subsequently grows on the internal surface of the porous material, forming a biocompatible and osteoconductive layer.

Preferably, the agitation of the solution is further employed to control the rate of release of carbon dioxide into the atmosphere above the solution, and to thereby control the rate of rinsing of pH within the solution.

Accordingly, the solution preferably includes a concentration of carbonate or bicarbonate ions in the range of approximately 1-50 mM, and more preferably 4-20 mM. As noted above, the concentration of carbonate ions is preferably provided by adding a quantity of sodium bicarbonate to the solution, which causes the pH of the solution to rise due to the formation and release of carbon dioxide.

The solution preferably further includes a concentration of HCl that is preferably added prior to the addition of a concentration of carbonate ions. A preferable concentration range of HCl is approximately 1-25 mM, and a more preferably range is 5-15 mM. HCl is preferably included to obtain an initial pH in the range disclosed above.

The calcifying solution may further comprise ions such as sodium, chlorine, potassium, sulfate, silicate and mixtures thereof. In a preferred embodiment, the calcifying solution comprises a concentration of Na and/or ions Cl in the range of approximately 100-1000 mM, and more preferably in the range of about 200-800 mM. Potassium ions may be provided with a concentration in the range of approximately 1-10 mM.

The calcifying solution is preferably maintained at a temperature of less than approximately 100° C., and more preferably between about 20° C. and 50° C.

The deposition rate and/or thickness of the apatitic coating can be adjusted by controlling one or more of many parameters. Such parameters include the temperature of the calcifying solution and the concentration of ions in the calcifying solution, particularly calcium, phosphate and carbonate. In a preferred embodiment, the contact time and/or immersion rate are selection to obtain a coating with a thickness in the range of 0.5-50 μm.

The coating rate is also dependent on the rate of change of pH of the solution, which can be controlled via the agitation speed or by controlling the partial pressure of carbon dioxide in the atmosphere above the solution. Specifically, the agitation rate can be employed to increase the rate of release of carbon dioxide gas from the solution, which increases the rate of change of pH within the solution. Preferably, the rate of change of pH, and accordingly, the deposition rate, is controlled by controlling the agitation speed from 100-800 rpm.

While prior art methods have required that the concentration of carbon dioxide in the atmosphere above the solution should be accurately controlled, the present inventors have found that a preferred deposition rate can be obtained by including an opening in the vessel that allows for the slow release of carbon dioxide gas. The opening is preferably millimeters in size. More preferably, the ratio of the surface area of the interface between the solution and the atmosphere above the solution to the area of the opening is in the range of approximately 2000-5000.

Coatings formed according to the methods of the invention may include biologically active agents such as growth factors, peptides, bone morphogenetic proteins, antibiotics, combinations thereof, and the like. In a preferred embodiment, bioactive agents as disclosed above are provided in solution and are co-precipitated and are thereby integrated into an apatatic layer within the porous structure.

Such integration of bioactive agents within a porous structure may result in the controlled release over a longer timescales then in prior art coating methods in which bioactive agents are primarily localized near the outer surface of a medical device. Furthermore, since the present invention does not require the calcifying solution to be periodically changed or replenished, bioactive agents are effectively conserved and their loss from the process is minimized.

The present invention may be adapted for use with a wide variety of porous materials made of metal, ceramic, polymeric materials, silicon, glass, and the like suitable as medical implants. Suitable materials include, but are not limited to for example, titanium, stainless steel, nickel, cobalt, niobium, molybdenum, aluminum, zirconium, tantalum, chromium, alloys thereof and combinations thereof. Exemplary ceramic materials include alumina, titania, and zirconia, glasses, and calcium phosphates, such as hydroxycalcium phosphate and tricalcium phosphate. Exemplary biodegradable polymeric materials include naturally occurring polymers such as cellulose, starch, chitosan, gelatin, casein, silk, wool, polyhydroxyalkanoates, lignin, natural rubber and synthetic polymers include polyesters such as polylactide (PLA), poly(glycolic acid) (PGA), poly(lactide-co-glycolide) (PLGA), poly(ε-caprolactone) (PCL), poly(3-hydroxy butyric acid) (PHB) and its copolymers, polyvinyl alcohol, polyamide esters, polyanhydrides, polyvinyl esters, polyalkylene esters, polyurethanes, other biocompatible polymeric material, and the like. Exemplary non-degradable polymeric materials include poly(methyl methacrylate) (PMMA), polyaryletheretherketone (PEEK), polyethylene, polypropylene, polystyrene, polycarbonates.

In a preferred embodiment, the porous structure is a polymer scaffold made from a polymer such as PLGA. In a more preferred embodiment, the polymer scaffold is a composite polymer scaffold comprising a polymer such as PLGA and calcium phosphate particles. Such a composite scaffold structure is disclosed in U.S. Pat. No. 7,022,522, which is incorporated herein by reference in its entirety.

Accordingly, the method may be employed to internally coat the pores of a macroporous polymer scaffold that comprises essentially non-membraneous pore walls consisting of microporous polymer struts. The struts define macropores which are interconnected by macroporous passageways, and the microporous polymer struts contain calcium phosphate particles dispersed therethrough and a binding agent for binding said calcium phosphate particles to a polymer making up the macroporous polymer scaffold. The structure also preferably contains microporous passageways extending through the microporous polymer struts so that macropores on either side of a given microporous polymer strut are in communication through the given microporous polymer strut.

The macroporous polymer structure preferably includes a network of macropores a mean diameter in a range from about 0.5 to about 3.5 mm. Furthermore, the macroporous polymer scaffold preferably has a porosity of at least 50%.

In a preferred embodiment, such a composite porous material is internally coated with a calcium phosphate layer by contacting the material with an aqueous solution comprising calcium ions, phosphate ions, and carbonate ions, where the initial pH of the solution is in the range of about 6.2 to 6.8 and temperature of the solution is in the range of approximately 20° C. to 50° C. The solution is agitated during the formation of the apatite layer, thus enabling the solution to infiltrate the porous structure and deposit a calcium phosphate coating on internal surfaces of the porous material. The solution preferably comprises NaCl with a concentration in the range of approximately 200-800 mM, CaCl₂.2H₂O with a concentration in the range of approximately 7-14 mM, HCl with a concentration in the range of approximately 5-15 mM, Na₂HPO₄ with a concentration in the range approximately 3-6 mM, and NaHCO₃ with a concentration in the range of approximately 4-20 mM. In a preferred embodiment, the porous material is added after dissolving NaHCO₃ into the solution, i.e. after the initiation of a rise in pH due to the formation and release of carbon dioxide.

Exemplary methods of coating such a composite porous scaffold are provided in the forthcoming examples.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### EXAMPLES

The following examples relate to a process for coating a hybrid composite PLGA-CaP macroporous scaffold with a calcium phosphate according to a preferred but non-limiting embodiment of the invention.

### Example 1

### Preparation of Solution

Under stirring, chemicals were dissolved in 1 liter ddH₂O the order as listed in Table 1 to provide a calcifying solution. Each chemical was added in sequence after the previous chemical had completely dissolved. While the sequence below is preferred, those skilled in the art will appreciate that the order of the first three chemicals may be varied.

TABLE 1
Preferred Concentrations for Calcifying Solution

| Order | Chemical | Concentration Range (mM) |
|---|---|---|
| 1 | NaCl | 200.0-740.0 |
| 2 | CaCl₂•2H₂O | 7-14 |
| 3 | HCl | 5.0-15.0 |
| 4 | Na₂HPO₄ | 3.0-6.0 |
| 5 | NaHCO₃ | 4.0-20.0 |

The prepared solution preferably has a pH value ranging from 6.2 to 6.8 and should be used for coating within 30 minutes of the addition of NaHCO₃ (due to the rapid release of CO₂ following the addition of NaHCO₃). If preferred, the solution may be initially prepared without adding NaHCO₃ and could be kept at room temperature prior to adding NaHCO₃.

### Example 2

### Method of Coating Scaffold

PLGA/CaP composite macroporous materials were fabricated according to the method disclosed in U.S. Pat. No. 7,022,522 (Example 10), which is incorporated herein by reference in its entirety.

1.0 g of scaffold cylinders were weighed and put into a plastic mesh bag. Depending on the coating thickness required, 300-600 ml calcifying solution was measured into a 1 L beaker with a stirrer. The mesh bag was completely immersed in the solution and immobilized. The beaker was sealed by an aluminum foil and two small holes with 1.6 mm diameter were created by a 16G needle. The beaker was then placed in a 37° C. water bath, where the material was incubated under constant stirring at a rate of 200-400 revolutions per minute.

The bath temperature and stirring rate were maintained over one day. The coated scaffold was removed from the mesh bag and rinsed 3 times by ddH₂O before being subsequently dried.

It was found that the coating thickness could be easily adjusted by changing the ratio of calcifying solution/coated substrate (volume/weight), or concentration of calcium and phosphate ions in the solution, and/or coating time.

### Example 3

### Characterization of Coating by X-Ray Diffraction (XRD) Analysis

The calcifying solution was kept at 37° C. under stirring for 24 hours, in the absence of a scaffold or other substrate material. The resultant precipitate was filtered, rinsed by ddH₂O and subsequently dried.

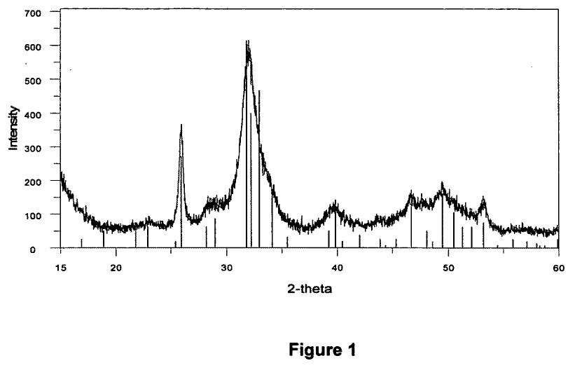

The produced white powder was collected and XRD analysis was conducted as shown in FIG. 1. The XRD patterns reveal that the product is composed of poorly crystalline hydroxyapatite (HA) similar to human bone mineral. Specifically, the peak at 25.81 2θ and between 31.7 and 33.1 2θ are characteristic of HA.

### Example 4

### Characterization of Coating by Scanning Electron Microscopy

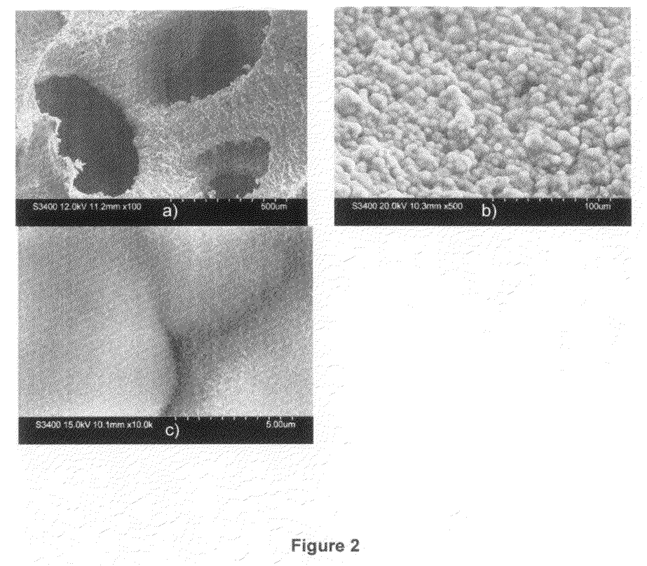

A large cube of 20×20×15 mm³ of macroporous PLGA/CaP composite scaffold was coated by immersing the cube in 650 ml calcifying solution for one day. The coated sample was rinsed by ddH₂O and dried. The morphology and the thickness of the coating were evaluated by using scanning electron microscopy (SEM). A series of sample sheets of 2 mm in thickness were then prepared by cutting the scaffold in the middle part to expose different internal surfaces of the scaffold. SEM images in FIGS. 2(a-c) reveal that dense and uniform HAp layers are observed on all the surface of the scaffold, (shown in FIG. 2(a)) demonstrating a thorough coating of calcium phosphate on the internal scaffold surfaces, even though the scaffold size is too big for other conventional coating methods to achieve a satisfactory coating. The layers are composed of micrometer sized globules or spherules (visible in FIG. 2(b) and FIG. 2(c)). The coating has a thickness averaging between 1 to 10 microns.

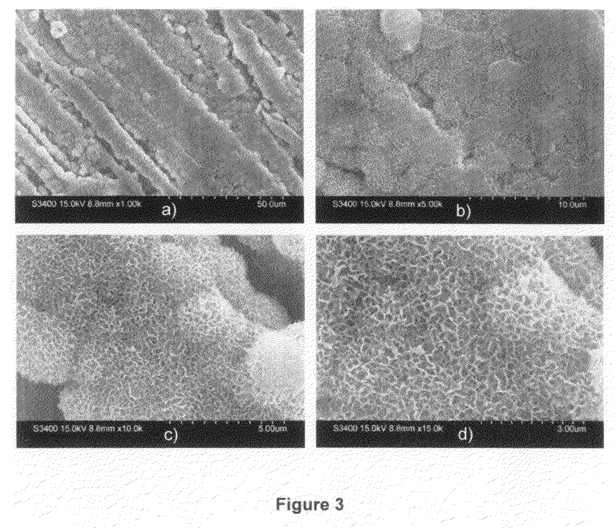

A polished polyaryletheretherketone (PEEK) polymer disk with a diameter of 15 mm and a thickness of 2 mm was coated by 50 ml calcifying solution for one day. The coated sample was rinsed by ddH₂O and dried. The sample was then examined by SEM. FIGS. 3(a)-(d) show that the polymer surface was completely coated by the apatite crystals.

### Example 5

### In-Vivo Histological Examination of Coated Implant

PLGA/CaP composite scaffold cylinders with a diameter of 2.1 mm and a length of 2-3 mm in length were coated by the method described above and irradiated for sterilization prior to implantation. The scaffolds were inserted into the hole at the distal end of the rat femur. Two weeks after the implantation, the rats were sacrificed and histological examination was performed by use of wax embedding and hematoxylin and eosin (HE) staining techniques (N=6).

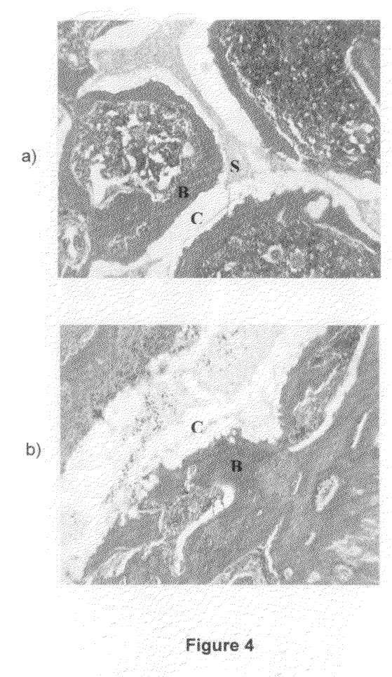

FIGS. 4(a) and 4(b) clearly showed that newly formed bone (B) directly contact the coating (C) on the scaffold surface (S) and grows along the outline of the coating. The crenellated morphology of bone at the interface that mirrored the globular morphology of the CaP coating was evidence that the bone formed was in direct contact with coating. The results demonstrate that the coated scaffold elicited excellent tissue responses by allowing new bone directly contact with the coating layers and expelling foreign body giant cells, thus eliminating the chronic inflammatory response usually associated with the tissue reaction to the underlying PLGA polymer.

### REFERENCES

1. Kim H M, Takadama H, Miyaji F, Kokubo T, Nishiguchi S, Nakamura T. Formation of bioactive functionally graded structure on Ti-6Al-4V alloy by chemical surface treatment. J Mater Sci Mater Med 2000; 11: 555-559.
2. Kokubo T, Kim H M, Kawashita M, Nakamura T. Bioactive metals: preparation and properties. J Mater Sci Mater Med 2004; 15: 99-107.
3. Oyane A, Onuma K, Ito A, Kim H M, Kokubo T, Nakamura T. Formation and growth of clusters in conventional and new kinds of simulated body fluids. J Biomed Mater Res 2003; 64A: 339-348.
4. Habibovic P, Barrere F, van Blitterswijk C A, de Groot K, Layrolle P. Biomimetic apatite coating on metal implants. J Am Ceram Soc 2002; 85: 517-522.
5. Barrere F, van Blitterswijk C A, de Groot K, Layrolle P. Influence of ionic strength and carbonate on the Ca—P coating formation from SBF×5 solution. Biomaterials 2002; 23: 1921-1930.
6. Barrere F, van Blitterswijk C A, de Groot K, Layrolle P. Nucleation of biomimetic Ca—P coatings on Ti6Al4V from SBF×5 solution: influence of magnesium. Biomaterials 2002; 23: 2211-2220.
7. Barrere F, van der Valk C M, Dalmeijer R A J, van Blitterswijk C A, de Groot K, Layrolle P. In vitro and in vivo degradation of biomimetic octacalcium phosphate and carbonate apatite coatings on titanium implants. J Biomed Mater Res 2003; 64A: 378-387.
8. Barrere F, van der Valk C M, Meijer G, Dalmeijer R A J, de Groot K, Layrolle P. Osteointegration of biomimetic apatite coating applied onto dense and porous metal implants in femurs of goats. J. Biomed Mater Res Part B: Appl Biomater 2003; 67B: 655-665.
9. Tas A C and Bhaduri S B, Rapid coating of Ti6Al4V at room temperature with a calcium phosphate solution similar to 10× simulated body fluid. J. Mater. Res. 2004; 19(9):2742-2749.

Therefore what is claimed is:

1. A method of forming a calcium phosphate coating on internal surface of a porous material, comprising the steps of:
providing an aqueous solution comprising calcium ions, phosphate ions, and carbonate ions, wherein said aqueous solution has a temperature less than approximately 100° C. and an initial pH in the range of approximately 6.0 to 7.5;
contacting said porous material with said solution; and
agitating said solution while forming said calcium phosphate coating on said internal surface of said porous material.

2. The method according to claim 1 wherein said step of agitating said solution comprises stirring said solution.

3. The method according to claim 1 wherein said solution is agitated at a speed of approximately 50-1000 revolutions per minute.

4. The method according to claim 3 wherein said solution is agitated at a speed of approximately 200-400 revolutions per minute.

5. The method according to claim 1 wherein said step of agitating said solution increases a rate of change of said pH of said solution by increasing a rate of extraction of carbon dioxide gas from said solution to an atmosphere above said solution.

6. The method according to claim 5 wherein said rate of change of pH of said solution is selected by controlling said agitation of said solution.

7. The method according to claim 1 wherein said carbonate ions are provided by adding a quantity of sodium bicarbonate to said solution.

8. The method according to claim 7 wherein said carbonate ions are present with a concentration in the range of approximately 1-50 mM.

9. The method according to claim 8 wherein said carbonate ions are present with a concentration in the range of approximately 4-20 mM.

10. The method according to claim 1 wherein said calcium ions are present with a concentration in the range of approximately 1-50 mM and said phosphate ions are present with a concentration in the range of approximately 1 to 25 mM.

11. The method according to claim 10 wherein said calcium ions are present with a concentration in the range of approximately 7 to 14 mM and said phosphate ions are present with a concentration in the range of approximately 3 to 6 mM.

12. The method according to claim 1 wherein said initial pH is in the range of approximately 6.2 to 6.8.

13. The method according to claim 1 wherein said temperature of said solution is in the range of approximately 20° C. to 50° C.

14. The method according to claim 1 wherein said aqueous solution further comprises additional ionic species selected from the group consisting of sodium, magnesium, chlorine, potassium, sulfate, silicate and mixtures thereof.

15. The method according to claim 14 wherein said sodium ions are present with a concentration in the range of approximately 100 to 1000 mM, said chloride ions are present with a concentration in the range of approximately 100 to 1000 mM said potassium ions are present with a concentration in the range of approximately 1 to 10 mM, said magnesium ions are present with a concentration in the range of approximately 0.1 to 10 mM.

16. The method according to claim 1 wherein a thickness of said calcium phosphate coating selected by controlling a parameter selected from the list comprising temperature, mixing rate, concentrations of ionic species, and any combination thereof.

17. The method according to claim 1 wherein a thickness of said calcium phosphate coating is in the range of approximately 0.5 to 50 μm.

18. The method according to claim 1 wherein said aqueous solution further comprises a bioactive material and said bioactive material is incorporated into said calcium phosphate coating.

19. The method according to claim 1 wherein said porous material comprises a connected network of macropores.

20. The method according to claim 19 wherein an average diameter of said macropores is greater than approximately 200 microns.

21. The method according to claim 1 wherein said porous material comprises a composite material formed of a macroporous polymer scaffold and calcium phosphate particles.

22. The method according to claim 21 wherein said macroporous polymer scaffold comprises essentially non-membraneous pore walls, said pore walls consisting of microporous polymer struts defining macropores which are interconnected by macroporous passageways, said microporous polymer struts containing calcium phosphate particles dispersed therethrough and a binding agent for binding said calcium phosphate particles to a polymer making up said macroporous polymer scaffold, microporous passageways extending through said microporous polymer struts so that macropores on either side of a given microporous polymer strut are in communication through said given microporous polymer strut.

23. The method according to claim 21 wherein said macroporous polymer structure comprises with macropores a mean diameter in a range from about 0.5 to about 3.5 mm, and said macroporous polymer scaffold has a porosity of at least 50%.

24. The method according to claim 1 wherein said porous material comprises a material with a porous surface layer coating a solid support.

25. The method according to claim 24 wherein said material with a porous surface layer comprises one of a beaded substrate and a porous undercut.

26. The method according to claim 1 wherein said solution is provided in a vessel comprising an opening with a size selected to obtain a desired rate of change of said pH.

27. The method according to claim 26 wherein a ratio of a surface area of an interface between said solution and an atmosphere above said solution to an area of said opening is in the range of approximately 2000-5000.

28. The method according to claim 1, further comprising the addition of a concentration of hydrochloric acid to said solution prior to contacting said porous material with said solution.

29. The method according to claim 28 wherein said concentration of hydrochloric acid in said solution is in the range of approximately 1-25 mM.

30. The method according to claim 29 wherein said concentration of hydrochloric acid in said solution is in the range of approximately 5-15 mM.

31. The method according to claim 1 wherein said calcium phosphate coating is hydroxyapatite.

32. A method of forming a calcium phosphate coating on internal surface of a macroporous material comprising a connected network of macropores, said method comprising the steps of:
providing an aqueous solution comprising calcium ions, phosphate ions, and carbonate ions, wherein said aqueous solution has a temperature less than approximately 100° C. and an initial pH in the range of approximately 6.0-7.5;
contacting said macroporous material with said solution; and
stirring said solution while forming said calcium phosphate coating on said internal surface of said macroporous material.

33. A method of forming a calcium phosphate coating on internal surface of a porous material comprising a composite material formed of a macroporous polymer scaffold and calcium phosphate particles, said method comprising the steps of: providing an aqueous solution comprising calcium ions, phosphate ions, and carbonate ions, wherein said aqueous solution has a temperature in the range of approximately 20° C.-50° C. and an initial pH in the range of approximately 6.0-7.5;
contacting said porous material with said solution; and
stirring said solution at a speed of approximately 200-400 revolutions per minute while forming said calcium phosphate coating on said internal surface of said porous material.

34. The method according to claim 33 where said solution comprises NaCl with a concentration in the range of approximately 200-800 mM, CaCl₂.2H₂O with a concentration in the range of approximately 7 14 mM, HCl with a concentration in the range of approximately 5-15 mM, Na₂HPO₄ with a concentration in the range approximately 3-6 mM, and NaHCO₃ with a concentration in the range of approximately 4-20 mM.
